(19) United States
(12) Patent Application Publication
(10) Pub. No.: US 2004/0207617 A1
(43) Pub. Date: Oct. 21, 2004

(54) Display circuit

(76) Inventor: Shoichiro Matsumoto, Gifu (JP)

Correspondence Address: CANTOR COLBURN, LLP, 55 GRIFFIN ROAD SOUTH, BLOOMFIELD, CT, 06002

(21) Appl. No.: 10/810,745

(22) Filed: Mar. 25, 2004

(30) Foreign Application Priority Data
Mar. 27, 2003 (JP) 2003-88238

(51) Int. Cl. G09G 5/00

(52) U.S. Cl. 345/211

(57) ABSTRACT

A pixel circuit having a selection TFT, a driver TFT, a storage capacitor, and an organic EL element is provided in each pixel. While maintaining the selection TFT at the on state, a current corresponding to a video signal is supplied to a current-to-voltage converter and a corresponding voltage is output to set this voltage to the storage capacitor. The driver TFT is switched on based on the voltage which is set in the storage capacitor and light is emitted from the organic EL element.

### BACKGROUND OF THE INVENTION

1. Field of the Invention

The present invention relates to a display circuit for allowing emissive elements disposed in a matrix form to emit light based on a video signal to achieve a display.

2. Description of the Related Art

Because electroluminescence (hereinafter simply referred to as “EL”) display devices in which a self-emitting EL element is used as an emissive element in each pixel have advantages such as that the device is thin, self-emitting, and consumes less power, EL display devices have attracted much attention as alternatives to display devices such as liquid crystal display (LCD) and cathode ray tube (CRT) display devices.

In particular, a high resolution display can be achieved by an active matrix EL display device in which a switching element such as a thin film transistor (hereinafter simply referred to as “TFT”) for individually controlling an EL element is provided in each pixel and the EL element in each pixel is controlled.

In an active matrix EL display circuit, a plurality of gate lines extend along a row direction over a substrate, a plurality of data lines and power supply lines extend along a column direction over the substrate, and each pixel has an organic EL element, a selection TFT, a driver TFT, and a storage capacitor. In this structure, a gate line is selected so that the selection TFT is switched on, a data voltage on a data line is charged into the storage capacitor, and the driver TFT is switched on by this data voltage to allow electric power to flow from a power supply line through the organic EL element.

Japanese Patent Laid-Open Publication No. 2001-147659 discloses a circuit in which a data current corresponding to a video signal is supplied onto a data line and the data current is supplied and flows through a current-to-voltage converter TFT to set a gate voltage of a driver TFT. In this circuit, a current-to-voltage converter TFT is formed for common use by two pixels.

With such a structure, by setting the gate voltage of the driver TFT based on a current flowing on the data line, it is possible to achieve a more precise control of a drive current of an EL element compared to a structure in which a voltage signal is supplied onto a data line. In addition, by commonly using the current-to-voltage converter TFT, it is possible to reduce the number of components.

In this circuit, however, there are problems in that the aperture ratio is reduced because the number of components to be placed within a pixel portion is large and the yield is reduced with the increase in the number of components. In addition, when common current-to-voltage converter elements are used, unevenness occurs in the aperture ratios among pixels, causing degradation of the display quality.

### SUMMARY OF THE INVENTION

The present invention advantageously provides a structure in which a current signal is converted into a voltage signal by a current-to-voltage converter and the voltage signal is supplied onto a data line. Therefore, the pixel circuit only requires a circuit with a simple structure driven by a voltage signal. In addition, because a voltage corresponding to a current signal is set on the data line while the pixel circuit is connected, it is possible to more precisely control driving of the pixel circuit compared to a configuration in which the voltage signal is directly supplied to the pixel circuit.

### BRIEF DESCRIPTION OF THE DRAWINGS

FIG. 1 is a diagram showing a structure according to a preferred embodiment of the present invention.

FIG. 2 is a diagram showing a structure according to another preferred embodiment of the present invention.

FIG. 3 is a diagram showing a structure according to another preferred embodiment of the present invention.

FIG. 4 is a diagram showing a structure according to still another preferred embodiment of the present invention.

FIG. 5 is a diagram showing a structure according to yet another preferred embodiment of the present invention.

FIG. 6 is a timing chart showing an operation according to the preferred embodiment of FIG. 1.

FIG. 7 is a diagram showing a structure according to another preferred embodiment of the present invention.

### DESCRIPTION OF PREFERRED EMBODIMENTS

Preferred embodiments of the present invention will now be described referring to the drawings.

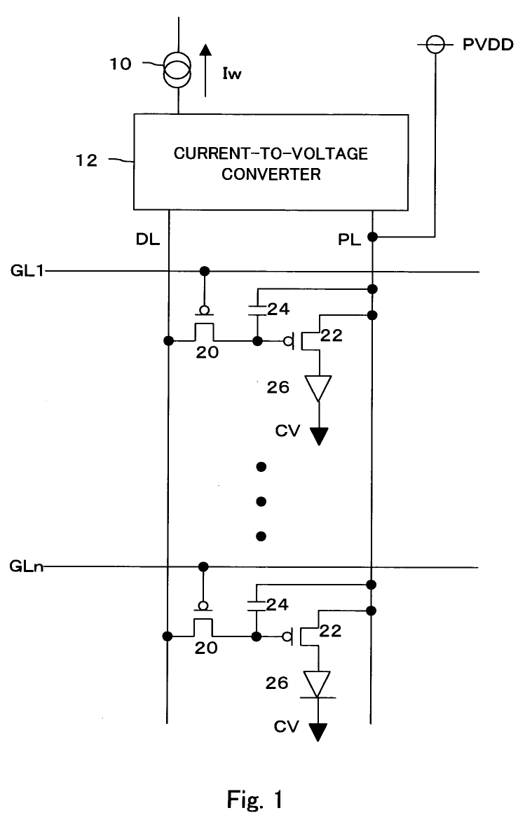

FIG. 1 is a diagram showing a structure according to a preferred embodiment of the present invention. A current source 10 provided for each data line DL supplies a current Iw corresponding to display data of each of pixels connected to the data line DL. A current-to-voltage converter 12 is connected to the current source 10.

A data line DL extending along the row direction is connected to the current-to-voltage converter 12 and display data for each of the pixels connected to the data line DL is sequentially supplied onto the data line DL as a voltage signal. The voltage signal supplied to the data line DL is a signal having a voltage which is smaller by a voltage corresponding to brightness of display data compared to a power supply PVDD of a high potential.

A structure of each pixel circuit connected to the data line DL will now be described. A source of a p-channel selection TFT 20 is connected to the data line DL, a gate of the selection TFT 20 is connected to a gate line GL of that row (GL1-GLn), and a drain of the selection TFT 20 is connected to a gate of a p-channel driver TFT 22. One terminal of a storage capacitor 24 is connected to a gate of the driver TFT 22 and the other terminal of the storage capacitor 24 is connected to a power supply line PL which is connected to the power supply PVDD and which extends along a column direction.

A source of the driver TFT 22 is connected to a power supply line PL and a drain of the driver TFT 22 is connected to an anode of an organic EL element 26. A cathode of the organic EL element 26 is connected to a cathode power supply CV of a low potential.

A number of pixel circuits each having such a structure are connected to the data line DL, the number being equal to the number of pixels on one column. The number of data lines DL is equal to the number of rows of pixels. Therefore, in a matrix of m rows by n columns, m pixel circuits are provided on one column, n columns of these pixel circuits are provided, n gate lines GL are provided, and m data lines DL are provided.

In such a circuit, a video signal is supplied as a current signal. For example, all current supplies 10 provided for each column supply a current Iw for display in the corresponding pixel based on a video signal of one horizontal line. With this structure, a voltage corresponding to the current Iw flowing from the current-to-voltage converter to the current source 10 is output.

On the other hand, a gate line GL of a row corresponding to the video signal to be supplied is set at an L level and selection TFTs 20 of the row connected to this gate line GL are switched on. Thus, the output from the current-to-voltage converter 12 is set at the gate of the driver TFT 22 and is stored in the storage capacitor 24.

In this configuration, the current-to-voltage converter 12 outputs a voltage corresponding to a current. This voltage is set while the gate of the driver TFT 22 for actually realizing the display is connected. In other words, the gate voltage of the driver TFT 22 is set at a voltage corresponding to the current which is input to the current-to-voltage converter 12. Therefore, the gate voltage of the TFT 22 can more precisely be set compared to a case in which a voltage signal is directly set on the gate of the driver TFT 22.

Because each of the pixel circuits comprises two TFTs, a storage capacitor, and an EL element similar to typical pixel circuits which operates based on a voltage signal, the number of components is small and the aperture ratio can be increased.

In the above-described structure, a storage capacitor 24 is provided. However, a driver element such as a TFT intrinsically has a parasitic capacitance. Therefore, it may not be necessary to actively provide a separate storage capacitor 24, and the storage capacitor 24 may be omitted.

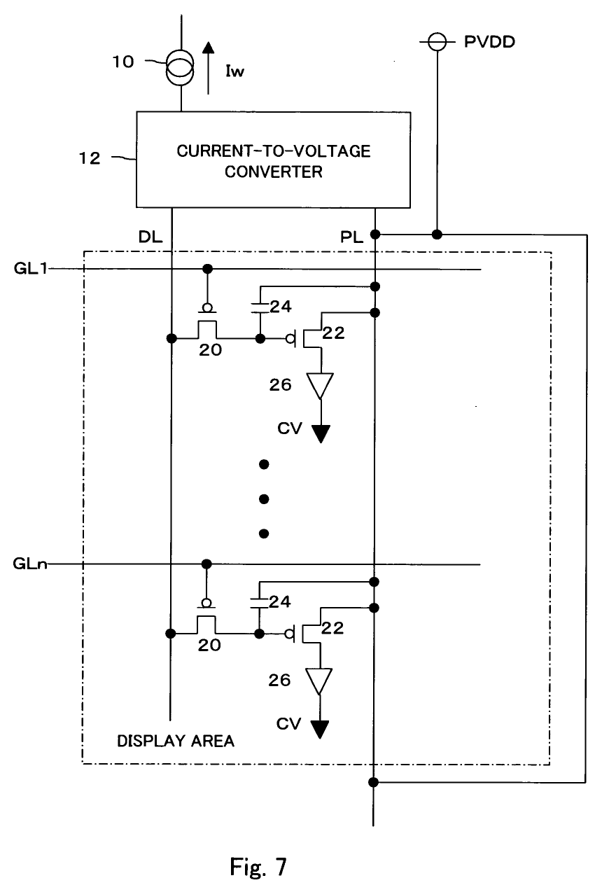

As shown in FIG. 7, it is also preferable that the power supply PVDD be directly input both from a side closer than the display region in which the pixels are arranged as seen from the current-to-voltage converter (proximate end) and from aside further than the display region as seen from the current-to-voltage converter (distal end). With such a structure, it is possible to reduce the voltage drop within a pixel.

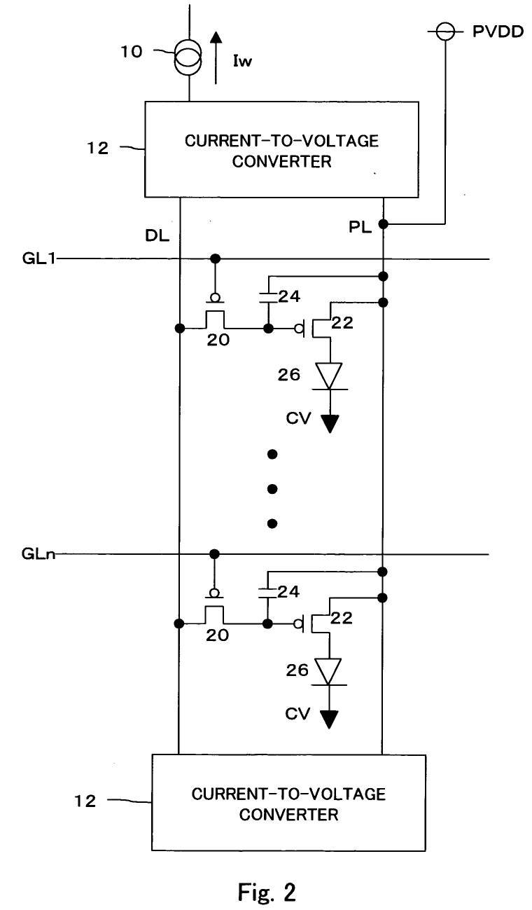

FIG. 2 shows a structure according to another preferred embodiment of the present invention. In the illustrated example structure, current-to-voltage converters 12 are provided on both ends of a data line DL. In this manner, by providing current-to-voltage converters 12 connected to both ends of the data line DL, it is possible to more suitably set the gate voltage of the driver TFT 22 regardless of the position of the pixel circuit.

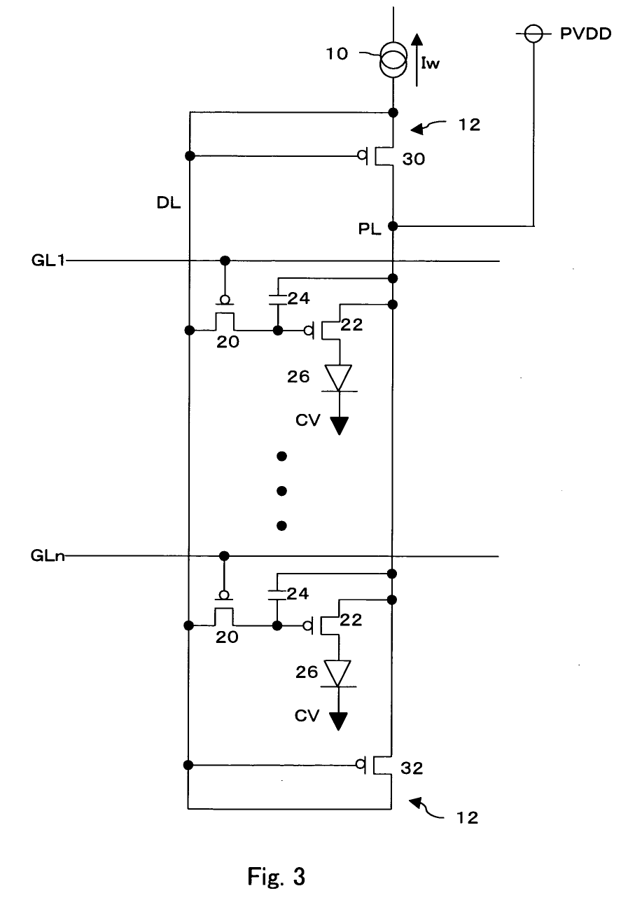

FIG. 3 is a diagram showing an internal structure of the current-to-voltage converter 12 in a structure shown in FIG. 2.

As shown, the current-to-voltage converter 12 comprises a p-channel TFT 30 which is diode-connected (i.e., the drain and gate are connected). A source of the TFT 30 is connected to the power supply line PL and a drain of the TFT 30 is connected to the current source 10. The drain and gate of the TFT 30 are connected to each other and to the data line DL.

While the selection TFT 20 is switched on, the TFT 30 and the driver TFT 22 form a current mirror structure. Therefore, a current which corresponds to the current Iw which actually flows through the current source 10 flows through the driver TFT 22 and the gate voltage of the driver TFT 22 during this current flow is stored in the storage capacitor 24. Thus, the gate voltage of the driver TFT 22 is set to a voltage for allowing a current Iw to flow through the driver TFT 22.

On the other end of the data line DL, a TFT 32 having its drain and gate connected is provided. As described, in view of circuits, the TFT 32 is connected in parallel with the TFT 30, and allows for stabilization of the voltage of the data line DL.

In FIG. 3, an example configuration is shown in which current-to-voltage converters (TFTs 30 and 32) 12 are provided on both ends of the data line DL, but the present embodiment is not limited to such a configuration and single current-to-voltage converter (TFT 30) 12 may be provided similar to the configuration of FIG. 1.

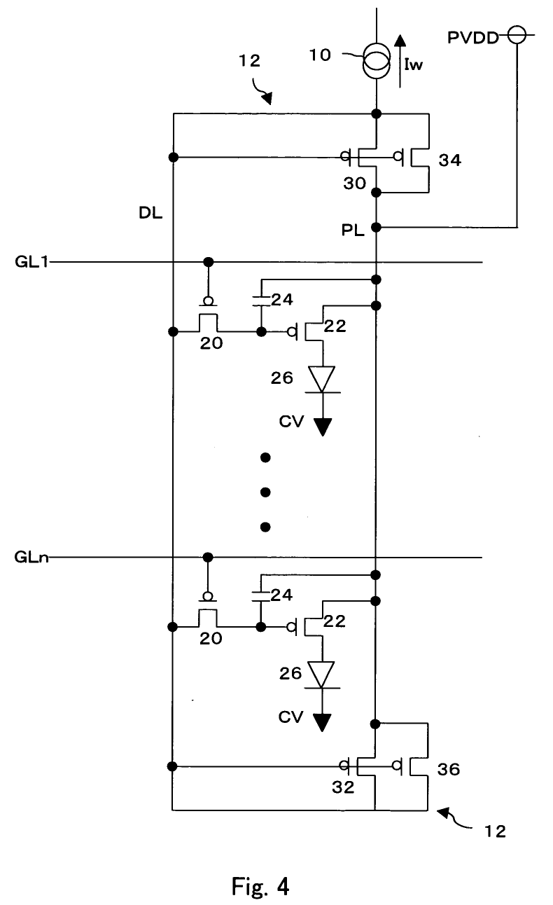

FIG. 4 shows a structure according to another preferred embodiment of the present invention. In this embodiment, TFTs 34 and 36 are provided in parallel with TFTs 30 and 32 which form current-to-voltage converters 12. More specifically, a source, a drain, and a gate of the TFT 34 are respectively connected to the source, the drain, and the gate of the TFT 30, and, similarly, a source, a drain, and a gate of the TFT 36 are respectively connected to the source, the drain, and the gate of the TFT 32. In this manner, by providing diode-connected TFTs in parallel, it is possible to achieve more precise conversion of current to voltage than when the parallel configuration is not employed.

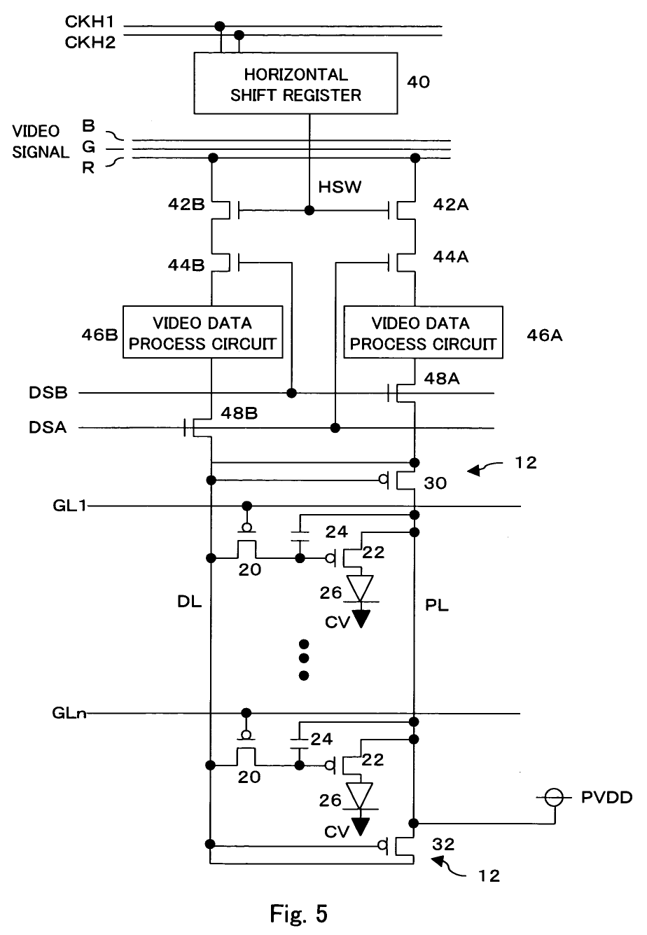

FIG. 5 shows an example structure of a panel which receives typical video signals and operates accordingly.

In the illustrated structure, a typical video signal in which a voltage value changes corresponding to each pixel in a horizontal line and the horizontal column is sequentially changed is input. The signal is input separately for R, G, and B. In the illustrated structure, a column of pixels which operate by an R signal is shown. A horizontal shift register 40 outputs a signal of H level at a timing of video signal components for the corresponding column (pixels) within the video signal.

Gates of a pair of n-channel TFTs 42A and 42B are connected to the output of the shift register 40. The TFTs 42A and 42B have respective drains connected to a video signal line (in the illustrated structure, R signal line). Sources of the TFTs 42A and 42B are respectively connected to drains of n-channel TFTs 44A and 44B and sources of the TFTs 44A and 44B are respectively connected to video data processor circuits 46A and 46B. Data selection signals DSA and DSB are input respectively to gates of the TFTs 44A and 44B.

The video data processor circuits 46A and 46B are provided corresponding to each column and respectively store input video signals corresponding to the pixels, converts the stored video signal into a current signal, and outputs the current signal. In FIG. 5, only one video data processor circuit 46A and one video data processor circuit 46B corresponding to one column within one line are shown. The video data processor circuits 46A and 46B respectively stores data for one pixel, and converts the stored data into a current and outputs the current over a period for one line. Two video data processor circuits 46A and 46B are provided in this configuration so that when video data for one line is sequentially input and stored in one of the video data processor circuits 46A and 46B (for example, the video data processor circuit 46A), this video data processor circuit (for example, the video data processor circuit 46A) outputs a current corresponding to the stored data during the next one line period, and the other video data processor circuit (for example, the video data processor circuit 46B) stores data for a subsequent line while the first video data processor circuit outputs the current.

The video data processor circuit comprises a capacitor which receives a video signal on one terminal and which has the other terminal connected to a power supply, and a transistor having a control terminal connected to one terminal of the capacitor for outputting a current from the power supply based on a charged voltage of the capacitor. Therefore, an output of the transistor is supplied to the current-to-voltage converter circuit 12 as a current signal corresponding to the video signal.

The outputs of the video data processor circuits 46A and 46B are respectively connected to drains of n-channel TFTs 48A and 48B, and selection signals DSA and DSB are respectively supplied to gates of the TFTs 48B and 48A. Sources of the TFTs 48B and 48A are connected to each other and are connected to the gate and source of the TFT 30 of the current-to-voltage converter 12.

While the video data processor 46A is switched on, the TFT 48B is switched on, and an output from the video data processor circuit 46B is supplied to the data current-to-voltage converter circuit 12. Similarly, when the video data processor 46B is switched on, the TFT 48A is switched on, and an output from the video data processor circuit 46A is supplied to the data current-to-voltage converter circuit 12. In this manner, after data for one line is written by the video signal of a previous line, this data of one line is then output for a period of one line, and these operations are repeated.

In this circuit, the pixel circuit has a structure similar to the above-described structure. Therefore, the gate voltage of the driver TFT 22 is determined based on a current flowing through the TFT 30 of the current-to-voltage converter circuit 12 and is stored by the storage capacitor 24, and light emission is maintained for a period of one frame.

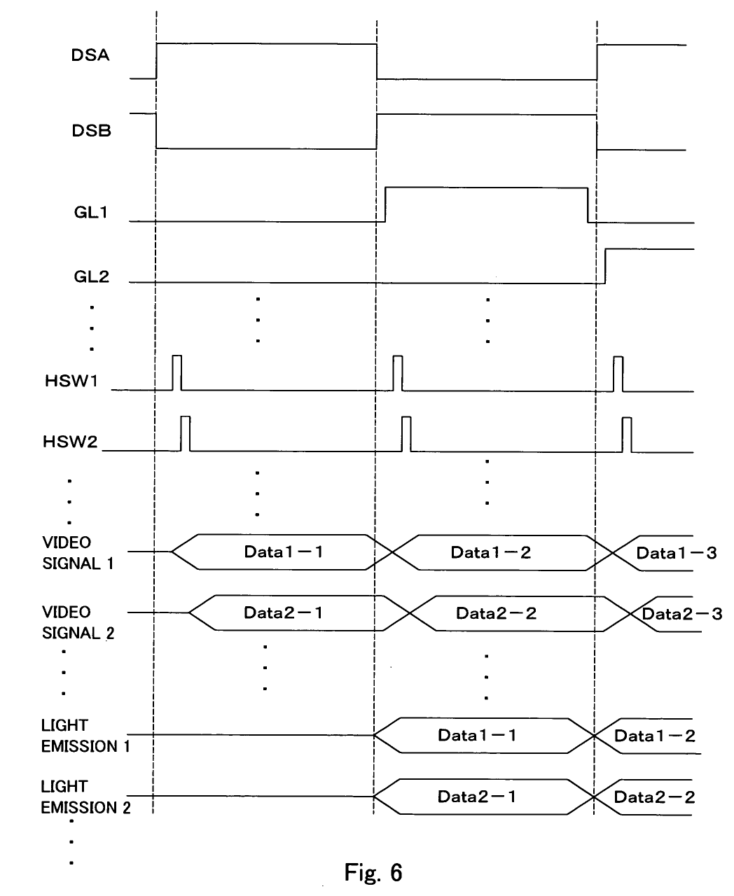

FIG. 6 is a timing chart of operations in a circuit of the embodiment of FIG. 5. Signals DSA and DSB are complementary signals in which H and L levels are repeated every 1 horizontal period (1H) and have opposite polarities. Signals HSW1, HSW2, . . . output from the shift register 40 are signals for controlling the video data processor circuits 46 in each column at a timing when the video data processor circuit is to read video signal data. The signals HSW1, HSW2, . . . corresponding to each column sequentially become an H level at the stage when signal components within the videos signal which correspond to the column are supplied so that the data signals are sequentially read by one of the video data processor circuits 46A and 46B corresponding to one of the TFTs 44A and 44B which is being switched on.

When the signal DSB is at H level, the video signal is read by the video data processor circuit 46A. When DSA becomes L level and DSB becomes H level in which period the video signal is to be read by the video data processor circuit 46B, line GL1 is at H level and the output from all of the video data processor circuits 46A is supplied onto data lines DL for a period of 1H. Thus, each pixel circuit emits light based on the Data1(column)-1(row), Data1-2, etc. Simultaneously, the video data of one line is sequentially stored in the video data processor circuit 46B.

In the next horizontal period, GL2 is at H level and the output from all of the video data processor circuits 46A is supplied onto the data lines DL for a period of 1H. Light is emitted from each pixel circuit based on the Data1-1, Data2-1, etc.

In this manner, according to the circuit of FIG. 5, the input video signal may be a typical video signal, and it is possible to precisely control an amount of current in each pixel circuit by converting the video signal into a current signal. In addition, there also is an advantage that the pixel circuit itself may be of a circuit with 2 TFTs which operates with a supply of voltage, and thus, the aperture ratio is not reduced.

In the above description, a current-to-voltage converter circuit 12 is provided for each column. The current-to-voltage converter circuit 12, however, only operates when data for the corresponding column is processed during one frame. Therefore, it is possible to provide a current-to-converter circuit 12 corresponding to a plurality of columns and switch the current-to-converter circuit 12.

A circuit as described above is typically formed over a glass substrate or the like. That is, on a TFT substrate, in addition to peripheral driver circuits and a pixel circuit for each pixel, an organic EL element for each pixel is formed. On the peripheral portion of the TFT substrate, a sealing substrate is attached covering at least the display region of the TFT substrate in order to maintain the space in which the display region is present as a dry and air-tight space. In addition, because a video signal, a predetermined clock, and a power supply are provided from outside of the panel, a terminal section is formed on the periphery of the TFT substrate. Such a display device may be mounted on a portable phone, digital camera, and other electrical equipments or may be a television device or a DVC replay display device.

What is claimed is:

1. A display circuit having an emissive element in each of pixels arranged in a matrix, the display circuit comprising:
a current-to-voltage converter circuit for sequentially converting a current signal corresponding to a video signal for each pixel in a column direction into a voltage signal;
a data line onto which the voltage signal output from the current-to-voltage converter circuit is sequentially supplied; and
a driver element provided in each pixel for receiving the voltage signal from the data line on a control terminal to control supply of current to the emissive element, wherein
the current-to-voltage converter circuit sets a voltage on the control terminal of the driver element by supplying a current corresponding to a video signal for a selected pixel and supplying a corresponding voltage signal to the data line.

2. A display circuit according to claim 1, wherein
each pixel has a storage capacitor for accumulating a voltage signal for the pixel supplied from the data line, and
a current corresponding to the voltage accumulated in the storage capacitor is supplied to the driver element and light is emitted from the emissive element.

3. A display circuit according to claim 1, wherein
a plurality of data lines are provided and one current-to-voltage converter circuit is provided corresponding to each data line.

4. A display circuit according to claim 1, wherein
a plurality of data lines are provided and a plurality of the current-to-voltage converter circuits are provided corresponding to each data line.

5. A display circuit according to claim 4, wherein
one current-to-voltage converter circuit is provided on each of two ends of each data line.

6. A display circuit according to claim 1, wherein
the current-to-voltage converter circuit comprises a diode-connected transistor for supplying a current signal corresponding to the video signal, and
a voltage on a control terminal of the diode-connected transistor is supplied to the data line.

7. A display circuit according to claim 6 wherein
the diode-connected transistor has a source connected to a power supply and a gate and a drain connected to the data line.

8. A display circuit according to claim 7, wherein
a selection transistor is placed between the data line and the control terminal of the driver element in each pixel, and
the driver element and the diode-connected transistor form a current mirror structure when the selection transistor is switched on.

9. A display circuit according to claim 1, wherein
the current-to-voltage converter circuit comprises a plurality of diode-connected transistors for supplying a current signal corresponding to the video signal, and
a voltage on a control terminal of the plurality of diode-connected transistors is supplied to the data line.

10. A display circuit according to claim 9, wherein
the plurality of diode-connected transistors have sources connected to a power supply and gates and drains connected to the data line.

11. A display circuit according to claim 10, wherein
a selection transistor is placed between the data line and the control terminal of the driver element in each pixel, and
the driver element and the diode-connected transistors form a current mirror structure when the selection TFT is switched on.

12. A display circuit according to claim 1, further comprising:
a converter circuit for receiving a video signal having a voltage indicative of brightness and for converting the received signal into a current signal corresponding to the video signal.
